(19) United States
(12) Patent Application Publication
(10) Pub. No.: US 2025/0216075 A1
(43) Pub. Date: Jul. 3, 2025

(54) ADDITIVELY MANUFACTURED COMBUSTOR WITH AIR RE-USE FROM AFT FRAME TO AXIAL FUEL STAGE INJECTOR(S)

(71) Applicant: GE Infrastructure Technology LLC, Greenville, SC (US)

(72) Inventor: Richard Martin DiCintio, Simpsonville, SC (US)

(21) Appl. No.: 18/399,830

(22) Filed: Dec. 29, 2023

(51) Int. Cl. F23R 3/00; F02C 7/22

(52) U.S. Cl. CPC F23R 3/002; F02C 7/22; F05D 2230/31; F05D 2240/35

(57) ABSTRACT

A combustor for a gas turbine system includes an additively manufactured (AM) combustor body including a one-piece member. The member includes a combustion liner including a cylindrical portion and a tapered transition portion, and at least one axial fuel stage (AFS) injector directed into the combustion liner. The member also includes an aft frame at an aft end of the tapered transition portion, the aft frame including a first cooling passage therein with an inlet and an outlet with the inlet in fluid communication with an air coolant source. A flow sleeve is spaced from an exterior surface of the tapered transition portion and defines a second, annular cooling passage therebetween. The second cooling passage extends from the outlet of the first cooling passage to an air inlet of AFS injector(s). The AM combustor body includes a plurality of parallel, sintered metal layers.

### TECHNICAL FIELD

The disclosure relates generally to turbomachine combustors and, more specifically, to an additively manufactured combustor body including a flow sleeve for directing re-use of air from an aft frame to axial fuel stage injector(s).

### BACKGROUND

Gas turbine systems include a combustion section including a plurality of combustors in which fuel is combusted to create a flow of combustion gas that is converted to kinetic energy in a downstream turbine section (e.g., an expansion turbine). Current combustors include a large number of parts that need to be cooled in an efficient manner. For example, a combustor may include a cylindrical portion of a combustion liner concentrically located inside a flow sleeve. Cooling air from a compressor discharge plenum is directed into an annulus defined between a cylindrical portion of the combustion liner and the flow sleeve to cool the cylindrical portion. A tapered transition portion of the combustion liner is coupled to an aft end of the cylindrical portion and transitions the hot gas path from the cylindrical portion's circular cross-section to a more arcuate, polygonal cross-section of a turbine inlet. The aforementioned flow sleeve may also direct cooling air along, or impinging on part of, the tapered transition portion. Air from the compressor discharge plenum may pass through impingement openings into an annulus between the transition portion and the downstream flow sleeve. Alternately, air may pass into the annulus via a gap between the downstream flow sleeve and an aft frame connected to the aft end of the transition portion. Air from the annulus can be directed to axial fuel stage (AFS) injectors that are positioned near a junction of the cylindrical portion and the tapered portion, through which the air and fuel are introduced into a secondary combustion zone.

The aft frame couples the tapered transition portion to the turbine inlet. Current combustors direct cooling air into the aft frame, where the cooling air is used for convective or impingement cooling of the aft frame. This cooling air is then exhausted to the first stage nozzle of the turbine, which is not an efficient use of the cooling air.

### BRIEF DESCRIPTION

All aspects, examples and features mentioned below can be combined in any technically possible way.

An aspect of the disclosure includes a combustor for a gas turbine system, the combustor comprising: an additively manufactured (AM) combustor body including a one-piece member including: a combustion liner including a cylindrical portion and a tapered transition portion; at least one axial fuel stage (AFS) injector directed into the combustion liner; an aft frame at an aft end of the tapered transition portion, the aft frame including a first cooling passage therein with an inlet and an outlet, the inlet in fluid communication with an air coolant source; and a first flow sleeve spaced from an exterior surface of the tapered transition portion and defining a second, annular cooling passage between the first flow sleeve and the tapered transition portion, the second, annular cooling passage extending from the outlet of the first cooling passage in the aft frame to an air inlet of the at least one AFS injector, wherein the AM combustor body further includes a plurality of parallel, sintered metal layers.

Another aspect of the disclosure includes any of the preceding aspects, and the first flow sleeve includes a first portion spaced from and parallel to the exterior surface of the tapered transition portion, and a second portion extending in an outwardly convex manner over the air inlet of the at least one AFS injector.

Another aspect of the disclosure includes any of the preceding aspects, and the at least one AFS injector includes at least two AFS injectors circumferentially spaced along at least one of the cylindrical portion and the tapered transition portion, and the second portion of the first flow sleeve extends at least partially circumferentially around the tapered transition portion to fluidly connect the air inlets of the at least two AFS injectors.

Another aspect of the disclosure includes any of the preceding aspects, and the first flow sleeve includes a plurality of openings therethrough and in fluid communication with the air coolant source.

Another aspect of the disclosure includes any of the preceding aspects, and further comprising a divider between the first flow sleeve and the exterior surface of the tapered transition portion, the divider defining a third cooling passage adjacent and fluidly separated from the second cooling passage, the third cooling passage extending from the plurality of openings to the air inlet of the at least one AFS injector.

Another aspect of the disclosure includes any of the preceding aspects, and the first cooling passage in the aft frame has a non-linear flow path in the aft frame.

Another aspect of the disclosure includes any of the preceding aspects, and further comprising a second flow sleeve spaced along at least a portion of an exterior surface of the cylindrical portion and defining a third cooling passage having an inlet adjacent the at least one AFS injector and extending to a head end fuel nozzle assembly coupled to a forward end of the AM combustor body.

Another aspect of the disclosure includes any of the preceding aspects, and the inlet to the third cooling passage is between an aft end of the second flow sleeve and a forward end of the first flow sleeve.

Another aspect of the disclosure includes any of the preceding aspects, and the first flow sleeve extends forwardly on opposing circumferential sides of the at least one AFS injector.

Another aspect of the disclosure includes a gas turbine (GT) system, comprising: a compressor section; a combustion section operatively coupled to the compressor section; and a turbine section operatively coupled to the combustion section, wherein the combustion section includes at least one combustor including: an additively manufactured (AM) combustor body including a one-piece member including: a combustion liner including a cylindrical portion and a tapered transition portion; at least one axial fuel stage (AFS) injector directed into the combustion liner; an aft frame at an aft end of the tapered transition portion, the aft frame including a first cooling passage therein with an inlet and an outlet, the inlet in fluid communication with an air coolant source; and a first flow sleeve spaced from an exterior surface of the tapered transition portion and defining a second, annular cooling passage between the first flow sleeve and the tapered transition portion, the second, annular cooling passage extending from the outlet of the first cooling passage in the aft frame to an air inlet of the at least one AFS injector, wherein the AM combustor body includes a plurality of parallel, sintered metal layers.

Another aspect of the disclosure includes any of the preceding aspects, and the first flow sleeve includes a first portion spaced from and parallel to the exterior surface of the tapered transition portion, and a second portion extending in an outwardly convex manner over the air inlet of the at least one AFS injector.

Another aspect of the disclosure includes any of the preceding aspects, and the at least one AFS injector includes at least two AFS injectors circumferentially spaced along at least one of the cylindrical portion and the tapered transition portion, and the second portion of the first flow sleeve extends at least partially circumferentially around the tapered transition portion to fluidly connect the air inlets of the at least two AFS injectors.

Another aspect of the disclosure includes any of the preceding aspects, and the first flow sleeve includes a plurality of openings therethrough and in fluid communication with the air coolant source.

Another aspect of the disclosure includes any of the preceding aspects, and further comprising a divider between the first flow sleeve and the at least portion of the exterior surface of the tapered transition portion, the divider defining a third cooling passage adjacent and fluidly separated from the second cooling passage, the third cooling passage extending from the plurality of openings to the air inlet of the at least one AFS injector.

Another aspect of the disclosure includes any of the preceding aspects, and the first cooling passage in the aft frame has a non-linear flow path in the aft frame.

Another aspect of the disclosure includes any of the preceding aspects, and further comprising a second flow sleeve spaced along at least a portion of an exterior surface of the cylindrical portion and defining a third cooling passage having an inlet adjacent the at least one AFS injector and extending to a head end fuel nozzle assembly coupled to a forward end of the AM combustor body.

Another aspect of the disclosure includes any of the preceding aspects, and the inlet to the third cooling passage is between an aft end of the second flow sleeve and a forward end of the first flow sleeve.

Another aspect of the disclosure includes any of the preceding aspects, and the first flow sleeve extends forwardly on opposing circumferential sides of the at least one AFS injector.

Two or more aspects described in this disclosure, including those described in this summary section, may be combined to form implementations not specifically described herein. That is, all embodiments described herein can be combined with each other.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a functional block diagram of an illustrative gas turbine system capable of use with a combustor and combustor body according to embodiments of the disclosure;

FIG. 2 shows a cross-sectional side view of a portion of a combustor with an additively manufactured combustor body according to embodiments of the disclosure;

FIG. 3 shows an end perspective view of a combustor body according to embodiments of the disclosure;

FIG. 4 shows a cross-sectional, perspective view of a combustor body according to embodiments of the disclosure;

FIG. 5 shows a cross-sectional view of metal layers of a combustor body according to embodiments of the disclosure;

FIG. 6A shows a cross-sectional view along view line A-A in FIG. 3 of a first flow sleeve and a tapered transition portion of a combustor body according to embodiments of the disclosure;

FIG. 6B shows a cross-sectional view along view line A-A in FIG. 3 of a first flow sleeve and a tapered transition portion of a combustor body according to other embodiments of the disclosure;

FIG. 7 shows an enlarged side cross-sectional view of a cooling passage in an aft frame of a combustor body according to embodiments of the disclosure;

FIG. 8 shows a schematic end view of an aft frame of a combustor body according to embodiments of the disclosure; and

FIG. 9 shows a schematic block diagram of an illustrative additive manufacturing system for additively manufacturing a combustor body according to embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the subject matter of the current disclosure, it will become necessary to select certain terminology when referring to and describing relevant machine components within the illustrative application of a turbomachine. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through a combustor of the turbomachine or, for example, the flow of air through the combustor or coolant through one of the turbomachine's component systems. The term “downstream” corresponds to the direction of flow of the fluid, and the term “upstream” refers to the direction opposite to the flow. The terms “forward” and “aft,” without any further specificity, refer to directions, with “forward” referring to the front or compressor end of the turbomachine, and “aft” referring to the rearward or turbine end of the turbomachine.

The term “axial” refers to movement or position parallel to an axis, e.g., an axis of a combustor or turbomachine. The term “radial” refers to movement or position perpendicular to an axis, e.g., an axis of a combustor or a turbomachine. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. Finally, the term “circumferential” refers to movement or position around an axis, e.g., a circumferential interior surface of a combustion liner or a circumferential interior of casing extending about a combustor. As indicated above and depending on context, it will be appreciated that such terms may be applied in relation to the axis of the combustor or the axis of the turbomachine.

In addition, several descriptive terms may be used regularly herein, as described below. The terms “first,” “second,” and “third,” may be used interchangeably to distinguish one component from another and are not intended to signify location or importance of the individual components.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event may or may not occur or that the subsequently described feature may or may not be present and that the description includes instances where the event occurs, or the feature is present and instances where the event does not occur, or the feature is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” or “directly coupled to” another element or layer, there are no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

Embodiments of the disclosure provide a combustor for a gas turbine system. The combustor includes an additively manufactured (AM) combustor body including a one-piece member. The one-piece member includes a combustion liner including a cylindrical portion and a tapered transition portion, and at least one axial fuel stage (AFS) injector directed into the combustion liner. The one-piece member also includes an aft frame at an aft end of the tapered transition portion. The aft frame includes a first cooling passage therein with an inlet and an outlet with the inlet in fluid communication with an air coolant source. A flow sleeve is spaced from an exterior surface of the tapered transition portion and defines a second, annular cooling passage between the first flow sleeve and the tapered transition portion. The second, annular cooling passage extends from the outlet of the first cooling passage in the aft frame to an air inlet of the at least one AFS injector. The AM combustor body includes a plurality of parallel, sintered metal layers.

The AM combustor body improves efficiency by using air for cooling the aft frame and then, rather than discarding it to a first stage nozzle, re-using it to cool the tapered transition portion and for combustion at the AFS injectors. Consequently, approximately 40% of the AFS injector(s) air is also used for cooling the tapered transition portion and/or the aft frame. The additive manufacturing enables formation of the AM combustor body as a single body and lowers the costs of the combustor body by eliminating numerous parts and many of the required assembly steps. The AM combustor body also improves durability compared to conventional versions by improving cooling, eliminating welds and providing the ability to design out stress-rising geometries, e.g., a high-stress weld between the aft end of the tapered transition portion and the aft frame.

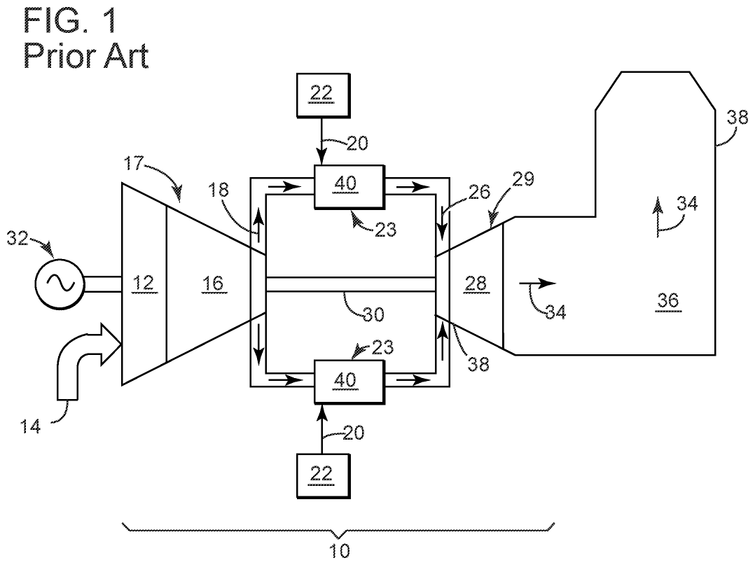

FIG. 1 shows a functional block diagram of an illustrative gas turbine (GT) system 10 that may incorporate various embodiments of a combustor 40 of the present disclosure. As shown, GT system 10 generally includes an inlet section 12 that may include a series of filters, cooling coils, moisture separators, and/or other devices to purify and otherwise condition a working fluid (e.g., air) 14 entering GT system 10. Working fluid 14 flows to a compressor 16 in a compressor section 17 that progressively imparts kinetic energy to working fluid 14 to produce a compressed air 18 (hereafter “air 18” or “compressed air 18”) at a highly energized state. Compressed air 18 is mixed with a fuel 20 from a fuel supply 22 to form a combustible mixture within at least one combustor 40 in a combustion section 23 that is operatively coupled to compressor section 17. The combustible mixture is burned to produce combustion gases 26 having a high temperature and pressure. Combustion gases 26 flow through a turbine 28 (e.g., an expansion turbine) of a turbine section 29 operatively coupled to combustion section 23 to produce work. For example, turbine 28 may be connected to a shaft 30 so that rotation of turbine 28 drives compressor 16 to produce compressed air 18. Alternately, or in addition, shaft 30 may connect turbine 28 to a generator 32 for producing electricity. Exhaust gases 34 from turbine 28 flow through an exhaust section 36 that connects turbine 28 to an exhaust stack 37 downstream from turbine 28. Exhaust section 36 may include, for example, a heat recovery steam generator (not shown) for cleaning and extracting additional heat from exhaust gases 34 prior to release to the environment. Where more than one combustor 40 is used, they may be circumferentially spaced around a turbine inlet 38 of turbine 28.

In one embodiment, GT system 10 may include a commercially available engine model from GE Vernova of Cambridge, MA. The present disclosure is not limited to any one particular GT system and may be implanted in connection with engines including, for example, any of the HA, F, B, LM, GT, TM and E-class engine models of GE Vernova, and engine models of other companies. Furthermore, the present disclosure is not limited to any particular turbomachine and may be applicable to, for example, steam turbines, jet engines, compressors, turbofans, etc.

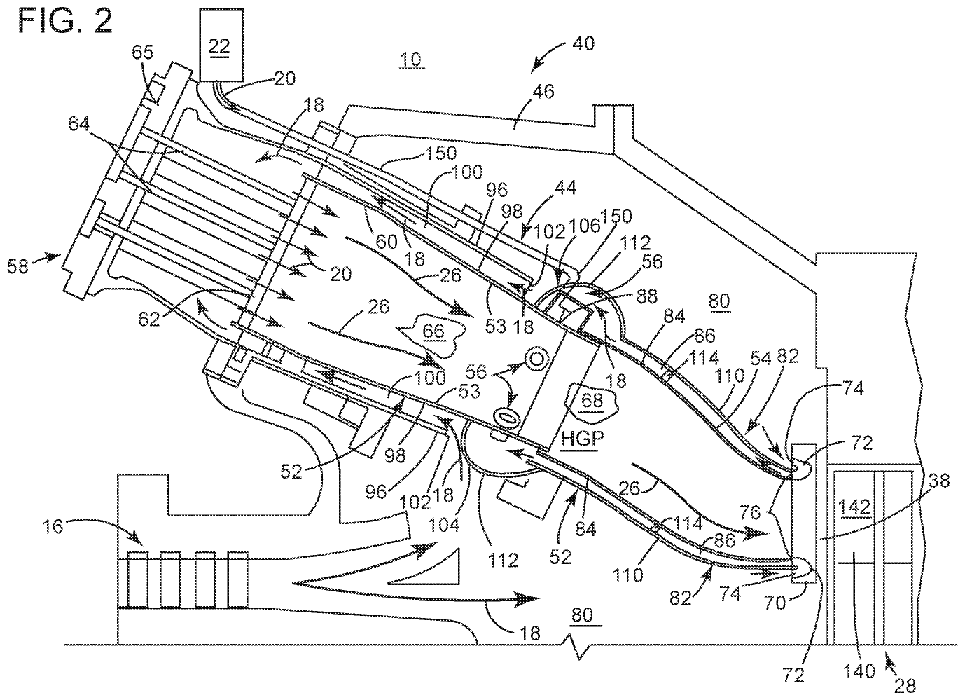

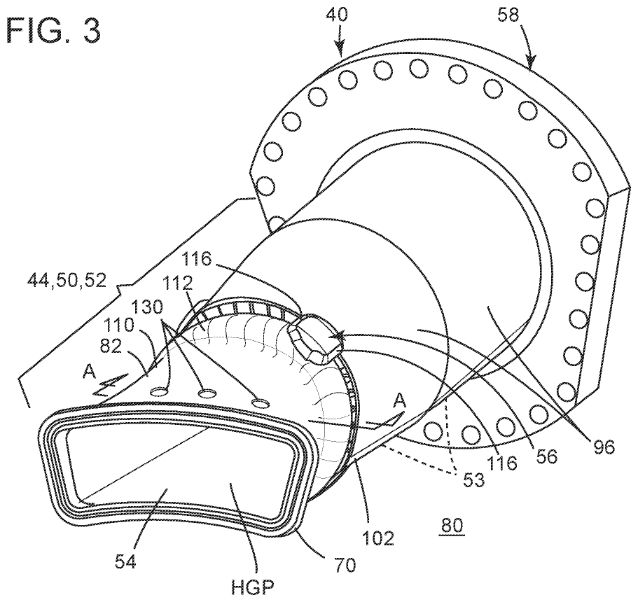

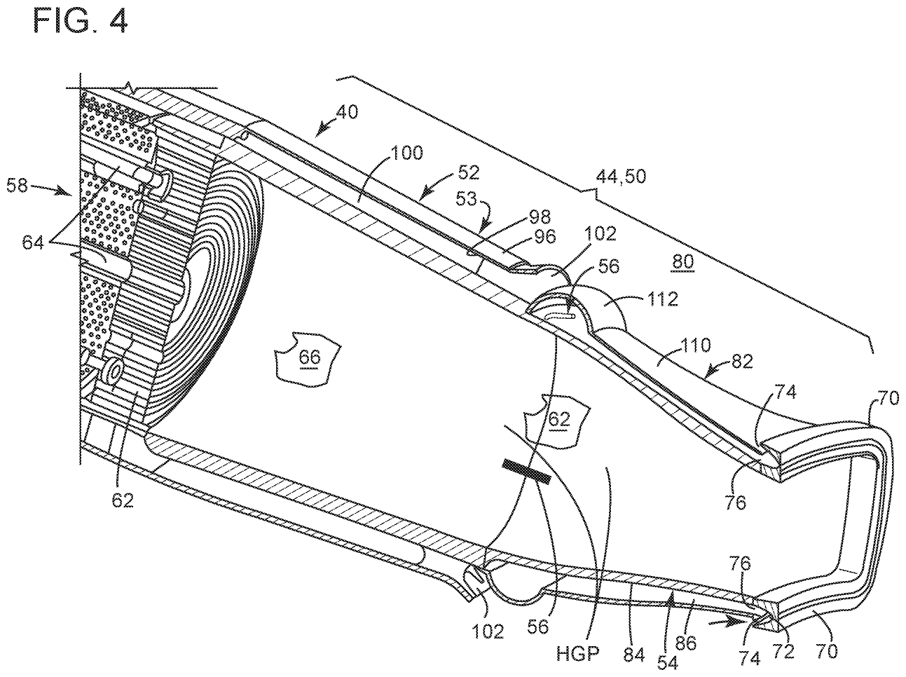

FIG. 2 shows a cross-sectional side view of combustor 40 positioned within GT system 10; FIG. 3 shows an end perspective view of combustor body 44; and FIG. 4 shows a cross-sectional perspective view of AM combustor body 44. As shown in FIG. 2, combustor 40 is at least partially surrounded by an outer casing 46 such as a compressor discharge casing and/or a turbine casing. An interior of outer casing 46 is in fluid communication with compressor 16.

Combustor 40 for GT system 10 includes AM combustor body 44 including a one-piece member 50. One-piece member 50 includes a combustion liner 52 including a cylindrical portion 53 and a tapered transition portion 54 at an aft end (right side as shown in FIGS. 2, 4) of cylindrical portion 53, and at least one axial fuel stage (AFS) injector 56 directed into combustion liner 52. Combustion liner 52, also known as a hot gas path (HGP) duct or unibody liner, extends downstream from a separate head end fuel nozzle assembly 58 (hereafter “head end assembly 58”) and a cap assembly 62 coupled to a forward end 60 of AM combustor body 44. That is, combustor 40 may also include a separate head end assembly 58 coupled to forward end 60 of AM combustor body 44. Head end assembly 58 generally includes at least one axially extending fuel nozzle 64 that extends downstream from an end cover 65 and a cap assembly 62 that extends radially and axially within outer casing 46 downstream from end cover 65. The cap assembly 62 defines the upstream boundary of the combustion chamber.

Head end assembly 58 may include any now known or later developed axially extending fuel nozzles 64 for delivering fuel 20 to primary combustion zone 66 from axially extending fuel nozzles 64. In certain embodiments, axially extending fuel nozzle(s) 64 of head end assembly 58 extend at least partially through cap assembly 62 to provide a combustible mixture of fuel and compressed air 18 to primary combustion zone 66. AFS injectors 56 extend radially through liner 52 downstream from axially extending fuel nozzle(s) 64. As will be described herein, compressed air 18 may be routed to AFS injector(s) 56 to combine with fuel 20 for combustion in a secondary combustion zone 68 that is downstream from primary combustion zone 66.

Tapered transition portion 54 at an aft end of cylindrical portion 53 transitions the hot gas path (HGP) from the liner's circular cross-section to a more arcuate, polygonal cross-section for coupling to turbine inlet 38 of turbine 28. Combustor 40 also includes an aft frame 70 at an aft end (right side in FIGS. 2, 4) of tapered transition portion 54. As will be described further herein, aft frame 70 includes a first cooling passage 72 therein with an inlet 74 and an outlet 76. Inlet 74 is in fluid communication with an air coolant source 80, e.g., interior of casing 46 filled with compressed air 18 from compressor 16 or other source of compressed air 18. Combustor 40 also includes a first flow sleeve 82 spaced from an exterior surface 84 of tapered transition portion 54 and defining a second, annular cooling passage 86 between (interior of) first flow sleeve 82 and (exterior surface 84 of) tapered transition portion 54. Second, annular cooling passage 86 extends circumferentially around tapered transition portion 54. In addition, second, annular cooling passage 86 extends from outlet 76 of first cooling passage 72 in aft frame 70 to an air inlet 88 of AFS injector(s) 56. In this manner, first flow sleeve(s) 82 with tapered transition portion 54 may route at least a portion of compressed air 18 from coolant source 80 to the one or more radially extending AFS injectors 56 to combine with fuel 20 for combustion in secondary combustion zone 68 that is downstream from primary combustion zone 66.

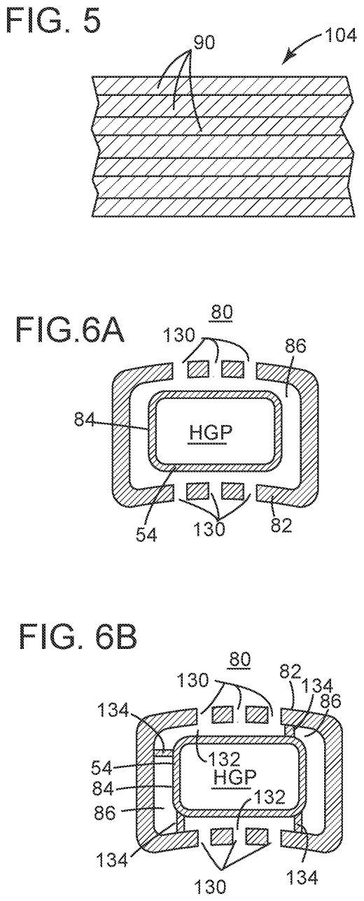

As a result of the additive manufacturing, there are no mechanical connections between the various parts (i.e., it is all one-piece). FIG. 5 shows a cross-sectional view of any portion of additively manufactured combustor body 44 (hereafter “AM combustor body 44” or “combustor body 44”). As shown in FIG. 5, AM combustor body 44 includes a plurality of parallel, sintered metal layers 90, i.e., from the additive manufacturing thereof.

Combustor 40, i.e., combustor body 44, may also include a second flow sleeve 96 spaced along at least a portion of an exterior surface 98 of cylindrical portion 53 of combustion liner 52 and defining a third cooling passage 100 having an inlet 102 adjacent AFS injector(s) 56 and extending to head end assembly 58 that is coupled to forward end 60 of AM combustor body 44. Second flow sleeve(s) 96 may define one or more third cooling passage(s) 100 for routing compressed air 18 from source 80 across an outer surface of cylindrical portion 53 of combustion liner 52. Second flow sleeve(s) 96 at least partially surrounds (annularly) at least a portion of combustion liner 52, e.g., at least a portion of cylindrical portion 53. Second flow sleeve 96 delivers air along third cooling passage 100 to cool cylindrical portion 53 of combustion liner 52, after which air 18 may also be used in head end assembly 58. Second flow sleeve 96 can be spaced from exterior surface of combustion cylindrical portion 53 in any manner, e.g., bosses, spacers, internal cooling passage structure, etc. As shown in FIG. 2, in certain embodiments, an inlet 102 to third cooling passage 100 is defined between an aft end 104 of second flow sleeve 96 and a forward end 106 of first flow sleeve 82. In other embodiments, as will be described, parts of second cooling passage 86 between first flow sleeve 82 and tapered transition portion 54 may be in fluid communication with third cooling passage 100.

First flow sleeve 82 can take a variety of forms to direct air from aft frame 70 to cool tapered transition portion 54 and deliver air to AFS injector(s) 56. In certain embodiments, as shown in FIG. 2, first flow sleeve 82 includes a first portion 110 spaced from and parallel to at least portion of exterior surface 84 of tapered transition portion 54, and a second portion 112 extending in an outwardly convex manner over air inlet 88 of AFS injector(s) 56. First portion 110 can have any shape that generally parallels that of tapered transition portion 54 over which it extends. First portion 110 can be spaced from exterior surface 84 of tapered transition portion 54 in any manner, e.g., bosses 114 (FIG. 2), internal cooling passage fin structure (not shown), etc., that does not impede air 18 flow through second cooling passage 86.

Second portion 112 may have any shape configured to collect air as part of second cooling passage 86 and deliver it to air inlets 88 of one or more AFS injector(s) 56, e.g., in a circumferential direction between AFS injector(s) 56. In certain embodiments, as shown in FIG. 2, second portion 112 may extend over air inlet(s) 88 of AFS injector(s) 56. In other embodiments, shown in FIG. 3, first flow sleeve 82, i.e., second portion 112 thereof, may extend forwardly on opposing circumferential sides 116 of AFS injector(s) 56, so air 18 therein can enter air inlets 88 from a circumferential side of AFS injectors 56. In any event, second portion 112 directs air from second cooling passage 86 to air inlet(s) 88 of AFS injector(s) 56. Air inlet(s) 88 can be in one or more of circumferential side(s) 116 (FIG. 3) and/or radial outer surface of AFS injector(s) 56 (FIG. 2).

As shown in FIGS. 2 and 3, where two or more AFS injectors 56 are present, they are typically circumferentially spaced along at least one of cylindrical portion 53 and/or tapered transition portion 54, i.e., spaced around the outside of cylindrical portion 53 and/or tapered transition portion 54. In this case, second portion 112 of first flow sleeve 82 extends at least partially circumferentially around tapered transition portion 54 to fluidly connect air inlets 88 of the at least two AFS injectors 56. In this manner, second portion 112 of first flow sleeve 82 provides a plenum to deliver air 18 to each AFS injector 56.

In certain embodiments, first flow sleeve 82, as shown in FIG. 2, may have a solid exterior wall. In other embodiments, shown in FIG. 3, first flow sleeve 82 may include a plurality of openings 130 therethrough, i.e., through the wall, and in fluid communication with air coolant source 80 and with second cooling passage 86. In this case, air 18 from coolant source 80 may mix with air 18 having passed through aft frame 70. FIG. 6A shows a cross-sectional view along view line A-A in FIG. 3 of first flow sleeve 82 and tapered transition portion 54 of combustor body 44 according to other embodiments of the disclosure. In this embodiment, second cooling passage 86 is fully annular, i.e., it has no interruptions therein in a circumferential direction around tapered transition portion 54 and within flow sleeve 82. Plurality of openings 130 may be in fluid communication with second cooling passage 86 in which air 18 passes directly from coolant source 80 without going through aft frame 70. Here, air 18 in second cooling passage 86 comes from aft frame 70 and from coolant source 80.

FIG. 6B shows a cross-sectional view along view line A-A in FIG. 3 of first flow sleeve 82 and tapered transition portion 54 of combustor body 44 according to additional embodiments of the disclosure. In these embodiments, plurality of openings 130 may be in fluid communication with another (fourth) cooling passage 132 (adjacent second cooling passage 86) in which air 18 passes directly from coolant source 80 without going through aft frame 70. That is, fourth cooling passage 132 is not in fluid communication with any outlet 76 of first cooling passage(s) 72 in aft frame 70, while second cooling passage 86, which is also between tapered transition portion 54 and first flow sleeve 82, is in fluid communication with outlet 76 of first cooling passage 72. As shown in FIG. 6B, one or more dividers 134 may be positioned between first flow sleeve 82 and at least portion of exterior surface 84 of tapered transition portion 54 to define second cooling passage 86 and fourth cooling passage 132. Divider(s) 134 may define fourth cooling passage 132 adjacent and fluidly separated from second cooling passage 86 for a portion of an axial extent between aft frame 70 and AFS injectors 56. Fourth cooling passage 132 may extend from plurality of openings 130 to air inlet(s) 88 of AFS injector(s) 56, i.e., to second portion 112 of first flow sleeve 82, to cool tapered transition portion 54 and to deliver air directly from coolant source 80 to AFS injector(s) 56, i.e., without going through aft frame 70.

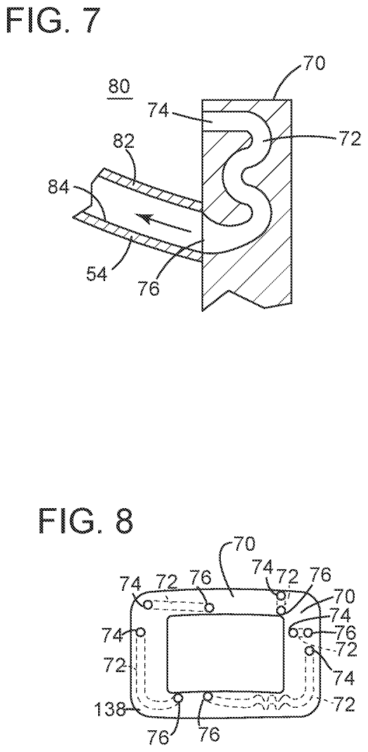

With further regard to first cooling passage 72 in aft frame 70, any number of first cooling passages 72 may extend through aft frame 70, limited only by the amount of space available to locate them. First cooling passage(s) 72 can have any cross-sectional shape and/or dimensions. In addition, first cooling passage(s) 72 can take a variety of paths through aft frame 70, e.g., linear, non-linear, or both. FIG. 7 shows an enlarged side cross-sectional view of first cooling passage 72 in aft frame 70. As illustrated, first cooling passage 72 can have a non-linear path, e.g., serpentine or other non-linear path as viewed from the side. In contrast, as shown in FIG. 2, first cooling passage 72 may have a U-shape cross-section.

FIG. 8 shows a schematic end view of aft frame 70 illustrating some examples of possible alternative paths for first cooling passage 72 in aft frame 70 as viewed from an end thereof. The upper right corner in FIG. 8 shows the vertical U-shaped passage of FIG. 2. However, first cooling passage 72 can flow anywhere through aft frame 70. For example, first cooling passages 72 may take a U-shape turn in a horizontal manner (center right example), pass around a corner 138 of aft frame 70 (lower left example), within a side of aft frame 70 (upper left example), or may take a non-linear path through aft frame 70 (lower right example). Each aft frame 70 can have a single form of the afore-described cooling passage 72 arrangements, or any variety of the afore-described cooling passage arrangements to provide a desired cooling of aft frame 70 and/or air delivery to AFS injector(s) 56.

As shown in FIG. 2, combustor 40 generally terminates at a point that is adjacent to a first stage 140 of stationary nozzles 142 of turbine 28. First stage 140 of stationary nozzles 142 at least partially defines turbine inlet 38 to turbine 28. Liner 52 at least partially defines a hot gas path (HGP) for routing combustion gases 26 from primary combustion zone 66 and secondary combustion zone 68 to turbine inlet 38 of turbine 28 during operation of GT system 10.

In operation, compressed air 18 flows from compressor 16 and is routed through various fluid flow passage(s). A portion of compressed air 18 is routed to head end assembly 58 of combustor 40 through second flow sleeve 96 where it reverses direction and is directed through axially extending fuel nozzle(s) 64. Compressed air 18 is mixed with fuel to form a first combustible mixture that is injected into primary combustion zone 66. The fuel may be the same fuel 20 supplied from fuel source 22 to AFS injectors 56, or it may be a different fuel or a different fuel source. The first combustible mixture is burned to produce combustion gases 26. A second portion of compressed air 18 may be routed through the radially extending AFS injectors 56 where it is mixed with fuel 20 from fuel passages 150 (e.g., conduits from fuel source 22 provided as external tubes (shown) or in second flow sleeve(s) 96) to form a second combustible mixture. The second combustible mixture is injected through liner 52 and into the hot gas path (HGP). The second combustible mixture at least partially mixes with combustion gases 26 and is burned in secondary combustion zone 68. Liner 52 at least partially defines hot gas path (HGP) for routing combustion gases 26 from primary combustion zone 66 and secondary combustion zone 68 to turbine inlet 38 of turbine 28 during operation of GT system 10.

As GT system 10 operates, compressed air 18 also enters inlet 74 of first cooling passage(s) 72 in aft frame 70 and cools aft frame 70. Air 18 in aft frame 70 then enters second, annular cooling passage 86 between first flow sleeve 82 and tapered transition portion 54 and is directed to inlet(s) 88 of AFS injector(s) 56 where it is used for combustion with fuel 20 in secondary combustion zone 68. In certain embodiments, air 18 can also be introduced to cooling passage 86 via openings 130 (FIG. 3). The re-use of air 18 from aft frame 70 is more efficient than discarding it to first stage 140 of stationary nozzles 142 and results in approximately 40% of air 18 used by AFS injector(s) 56 also being used for cooling tapered transition portion 54 among other parts of combustion body 44.

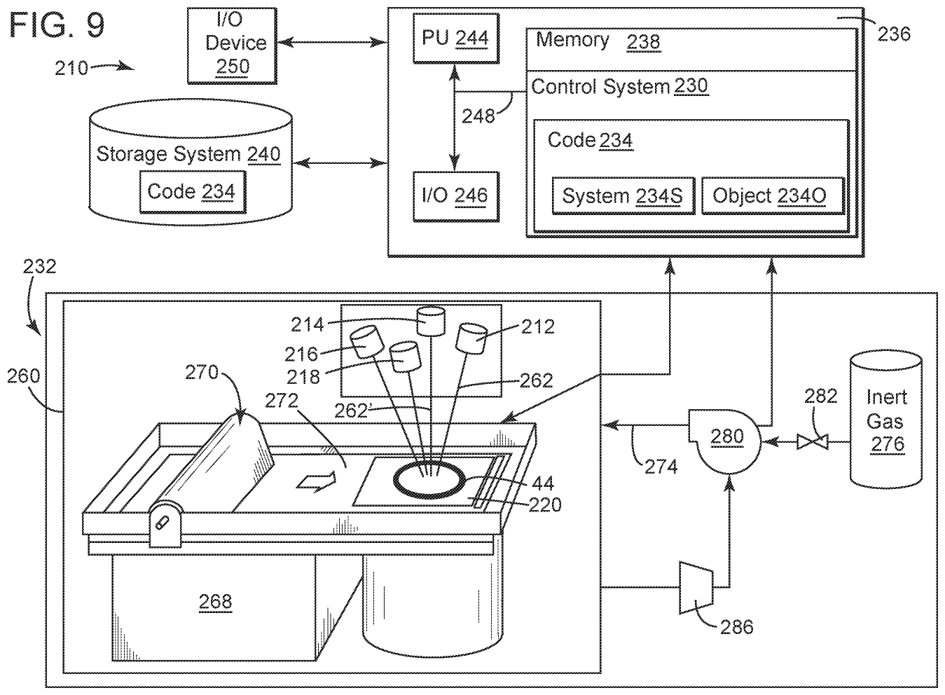

Combustor 40 and AM combustor body 44 may be additively manufactured using any now known or later developed technique capable of forming the large, integral body. FIG. 9 shows a schematic/block view of an illustrative computerized metal powder additive manufacturing system 210 (hereinafter ‘AM system 210’) for generating AM combustor body 44, of which only a single layer is shown. The teachings of the disclosures will be described relative to building AM combustor body 44 using multiple melting beam sources 212, 214, 216, 218, but it is emphasized and will be readily recognized that the teachings of the disclosure are equally applicable to build AM combustor body 44 using any number of melting beam sources. In this example, AM system 210 is arranged for direct metal laser melting (DMLM). It is understood that the general teachings of the disclosure are equally applicable to other forms of metal powder additive manufacturing such as but not limited to selective laser melting (SLM), and perhaps other forms of additive manufacturing (i.e., other than metal powder applications). The layer of AM combustor body 44 in build platform 220 is illustrated in FIG. 9 as a circular element; however, it is understood that the additive manufacturing process can be readily adapted to manufacture any shaped part of AM combustor body 44 on build platform 220.

AM system 210 generally includes an additive manufacturing control system 230 (“control system”) and an AM printer 232. As will be described, control system 230 executes set of computer-executable instructions or code 234 to generate combustor body 44 using multiple melting beam sources 212, 214, 216, 218. In the example shown, four melting beam sources may include four lasers. However, the teachings of the disclosures are applicable to any melting beam source, e.g., an electron beam, laser, etc. Control system 230 is shown implemented on computer 236 as computer program code. To this extent, computer 236 is shown including a memory 238 and/or storage system 240, a processor unit (PU) 244, an input/output (I/O) interface 246, and a bus 248. Further, computer 236 is shown in communication with an external I/O device/resource 250. In general, processor unit (PU) 244 executes computer program code 234 that is stored in memory 238 and/or storage system 240. While executing computer program code 234, processor unit (PU) 244 can read and/or write data to/from memory 238, storage system 240, I/O device 250 and/or AM printer 232. Bus 248 provides a communication link between each of the components in computer 236, and I/O device 250 can comprise any device that enables a user to interact with computer 236 (e.g., keyboard, pointing device, display, etc.).

Computer 236 is only representative of various possible combinations of hardware and software. For example, processor unit (PU) 244 may comprise a single processing unit or may be distributed across one or more processing units in one or more locations, e.g., on a client and server. Similarly, memory 238 and/or storage system 240 may reside at one or more physical locations. Memory 238 and/or storage system 240 can comprise any combination of various types of non-transitory computer readable storage medium including magnetic media, optical media, random access memory (RAM), read only memory (ROM), etc. Computer 236 can comprise any type of computing device such as an industrial controller, a network server, a desktop computer, a laptop, a handheld device, etc.

As noted, AM system 210 and, in particular control system 230, executes code 234 to generate combustor body 44. Code 234 can include, among other things, a set of computer-executable instructions 234S (herein also referred to as ‘code 234S’) for operating AM printer 232, and a set of computer-executable instructions 234O (herein also referred to as ‘code 234O’) defining AM combustor body 44 to be physically generated by AM printer 232. As described herein, additive manufacturing processes begin with a non-transitory computer readable storage medium (e.g., memory 238, storage system 240, etc.) storing code 234. Set of computer-executable instructions 234S for operating AM printer 232 may include any now known or later developed software code capable of operating AM printer 232.

The set of computer-executable instructions 234O defining combustor body 44 may include a precisely defined 3D model of combustor body 44 and can be generated from any of a large variety of well-known computer aided design (CAD) software systems such as AutoCAD®, TurboCAD®, DesignCAD 3D Max, etc. In this regard, code 234O can include any now known or later developed file format. Furthermore, code 234O representative of combustor body 44 may be translated between different formats. For example, code 234O may include Standard Tessellation Language (STL) files which were created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any AM printer. Code 234O representative of combustor body 44 may also be converted into a set of data signals and transmitted, received as a set of data signals and converted to code, stored, etc., as necessary. Code 234O may be configured according to embodiments of the disclosure to allow for formation of border and internal sections in overlapping field regions, as will be described. In any event, code 234O may be an input to AM system 210 and may come from a part designer, an intellectual property (IP) provider, a design company, the operator or owner of AM system 210, or from other sources. In any event, control system 230 executes code 234S and 234O, dividing combustor body 44 into a series of thin slices that assembles using AM printer 232 in successive layers of material.

AM printer 232 may include a processing chamber 260 that is sealed to provide a controlled atmosphere for combustor body 44 printing. A build platform 220, upon which combustor body 44 is built, is positioned within processing chamber 260. A number of melting beam sources 212, 214, 216, 218 are configured to melt layers of metal powder on build platform 220 to generate combustor body 44. While four melting beam sources 212, 214, 216, 218 are illustrated, it is emphasized that the teachings of the disclosure are applicable to a system employing any number of sources, e.g., 1, 2, 3, or 5 or more. As understood in the field, each melting beam source 212, 214, 216, 218 may have a field including a non-overlapping field region, respectively, in which it can exclusively melt metal powder, and may include at least one overlapping field region in which two or more sources can melt metal powder. In this regard, each melting beam source 212, 214, 216, 218 may generate a melting beam, respectively, that fuses particles for each slice, as defined by code 234O. For example, in FIG. 9, melting beam source 212 is shown creating a layer of combustor body 44 using melting beam 262 in one region, while melting beam source 214 is shown creating a layer of combustor body 44 using melting beam 262′ in another region. Each melting beam source 212, 214, 216, 218 is calibrated in any now known or later developed manner. That is, each melting beam source 212, 214, 216, 218 has had its laser or electron beam's anticipated position relative to build platform 220 correlated with its actual position in order to provide an individual position correction (not shown) to ensure its individual accuracy. In one embodiment, each of plurality melting beam sources 212, 214, 216, 218 may create melting beams, e.g., 262, 262′, having the same cross-sectional dimensions (e.g., shape and size in operation), power and scan speed.

Continuing with FIG. 9, an applicator (or re-coater blade) 270 may create a thin layer of raw material 272 spread out as the blank canvas from which each successive slice of the final combustor body 44 will be created. Various parts of AM printer 232 may move to accommodate the addition of each new layer, e.g., a build platform 220 may lower and/or chamber 260 and/or applicator 270 may rise after each layer. The process may use different raw materials in the form of fine-grain metal powder, a stock of which may be held in a chamber 268 accessible by applicator 270. In the instant case, combustor body 44 may be made of a metal which may include a pure metal or an alloy. In one example, the metal may include practically any non-reactive metal powder, i.e., non-explosive or non-conductive powder, such as but not limited to: a cobalt chromium molybdenum (CoCrMo) alloy, stainless steel, an austenite nickel-chromium based alloy such as a nickel-chromium-molybdenum-niobium alloy (NiCrMoNb) (e.g., Inconel 625 or Inconel 718), a nickel-chromium-iron-molybdenum alloy (NiCrFeMo) (e.g., Hastelloy® X available from Haynes International, Inc.), or a nickel-chromium-cobalt-molybdenum alloy (NiCrCoMo) (e.g., Haynes 282 available from Haynes International, Inc.). Other possibilities include, for example, René 52, CM 247, Mar M 247 and any precipitation harden-able (PH) nickel alloy.

Processing chamber 260 is filled with an inert gas such as argon or nitrogen and controlled to minimize or eliminate oxygen. Control system 230 is configured to control a flow of a gas mixture 274 within processing chamber 260 from a source of inert gas 276. In this case, control system 230 may control a pump 280, and/or a flow valve system 282 for inert gas to control the content of gas mixture 274. Flow valve system 282 may include one or more computer controllable valves, flow sensors, temperature sensors, pressure sensors, etc., capable of precisely controlling flow of the particular gas. Pump 280 may be provided with or without valve system 282. Where pump 280 is omitted, inert gas may simply enter a conduit or manifold prior to introduction to processing chamber 260. Source of inert gas 276 may take the form of any conventional source for the material contained therein, e.g., a tank, reservoir or other source. Any sensors (not shown) required to measure gas mixture 274 may be provided. Gas mixture 274 may be filtered using a filter 286 in a conventional manner.

In operation, build platform 220 with metal powder thereon is provided within processing chamber 260, and control system 230 controls flow of gas mixture 274 within processing chamber 260 from source of inert gas 276. Control system 230 also controls AM printer 232, and in particular, applicator 270 and melting beam sources 212, 214, 216, 218 to sequentially melt layers of metal powder on build platform 220 to generate combustor body 44 according to embodiments of the disclosure. While a particular AM system 210 has been described herein, it is emphasized that the teachings of the disclosure are not limited to any particular additive manufacturing system or method.

Once AM combustor body 44 is formed, as shown in FIG. 2, it may be assembled with other parts of combustor 40 and/or connected to turbine inlet 38. For example, head end assembly 58 may be coupled to forward end 60 of combustor body 44. Head end assembly 58 may be coupled in any now known or later developed fashion, such as welding or fasteners (with or without seals). In addition, aft frame 70 may be coupled to turbine inlet 38 in any now known or later developed fashion, such as welding or fasteners (also with or without seals).

The disclosure provides various technical and commercial advantages, examples of which are discussed herein. As noted, the AM combustor body improves efficiency by using air for cooling the aft frame and then for the AFS injectors that is usually used for purging a first stage nozzle gap but otherwise discarded. Consequently, approximately 40% of the AFS injector(s) air is also used for cooling the tapered transition portion among other parts of the combustor body. The additive manufacturing enables formation of the AM combustor body as a single body and lowers the costs of the combustor body by eliminating numerous parts and many of the required assembly steps. The AM combustor body also improves durability compared to conventional versions by improving cooling, eliminating welds, and providing the ability to design out stress-rising geometries, e.g., a high-stress weld between the aft end of the tapered transition portion and the aft frame.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

1. A combustor for a gas turbine system, the combustor comprising:
an additively manufactured (AM) combustor body including a one-piece member including:
a combustion liner including a cylindrical portion and a tapered transition portion;
at least one axial fuel stage (AFS) injector directed into the combustion liner;
an aft frame at an aft end of the tapered transition portion, the aft frame including a first cooling passage therein with an inlet and an outlet, the inlet in fluid communication with an air coolant source; and
a first flow sleeve spaced from an exterior surface of the tapered transition portion and defining a second, annular cooling passage between the first flow sleeve and the tapered transition portion, the second, annular cooling passage extending from the outlet of the first cooling passage in the aft frame to an air inlet of the at least one AFS injector, wherein a first supply of coolant air from the air coolant source is provided from the aft frame to the air inlet of the at least one AFS injector through the second, annular cooling passage;
a plurality of openings extending through the first flow sleeve and in fluid communication with the air coolant source;
a divider between the first flow sleeve and the exterior surface of the tapered transition portion, the divider separating an additional cooling passage from the second, annular cooling passage, the additional cooling passage extending from the plurality of openings in the first flow sleeve to the air inlet of the at least one AFS injector, wherein a second supply of coolant air is provided directly from the coolant air source to the air inlet of the at least one AFS injector through the additional cooling passage without passing through the aft frame.

2. The combustor of claim 1, wherein the first flow sleeve includes a first portion spaced from and parallel to the exterior surface of the tapered transition portion, and a second portion extending in an outwardly convex manner over the air inlet of the at least one AFS injector.

3. The combustor of claim 2, wherein the at least one AFS injector includes at least two AFS injectors circumferentially spaced along at least one of the cylindrical portion and the tapered transition portion, and the second portion of the first flow sleeve extends at least partially circumferentially around the tapered transition portion to fluidly connect the air inlets of the at least two AFS injectors.

4. (canceled)

5. (canceled)

6. The combustor of claim 1, wherein the first cooling passage in the aft frame has a non-linear flow path in the aft frame.

7. The combustor of claim 1, further comprising a second flow sleeve spaced along at least a portion of an exterior surface of the cylindrical portion and defining a third cooling passage having an inlet adjacent the at least one AFS injector and extending to a head end fuel nozzle assembly coupled to a forward end of the AM combustor body.

8. The combustor of claim 7, wherein the inlet to the third cooling passage is between an aft end of the second flow sleeve and a forward end of the first flow sleeve.

9. The combustor of claim 1, wherein the first flow sleeve extends forwardly on opposing circumferential sides of the at least one AFS injector.

10. A gas turbine (GT) system, comprising:
a compressor section;
a combustion section operatively coupled to the compressor section; and
a turbine section operatively coupled to the combustion section,
wherein the combustion section includes at least one combustor including:
an additively manufactured (AM) combustor body including a one-piece member including:
a combustion liner including a cylindrical portion and a tapered transition portion;
at least one axial fuel stage (AFS) injector directed into the combustion liner;
an aft frame at an aft end of the tapered transition portion, the aft frame including a first cooling passage therein with an inlet and an outlet, the inlet in fluid communication with an air coolant source; and
a first flow sleeve spaced from an exterior surface of the tapered transition portion and defining a second, annular cooling passage between the first flow sleeve and the tapered transition portion, the second, annular cooling passage extending from the outlet of the first cooling passage in the aft frame to an air inlet of the at least one AFS injector, wherein a first supply of coolant air from the air coolant source is provided from the aft frame to the air inlet of the at least one AFS injector through the second, annular cooling passage;
a plurality of openings extending through the first flow sleeve and in fluid communication with the air coolant source;
a divider between the first flow sleeve and the exterior surface of the tapered transition portion, the divider separating an additional cooling passage from the second, annular cooling passage, the additional cooling passage extending from the plurality of openings in the first flow sleeve to the air inlet of the at least one AFS injector, wherein a second supply of coolant air is provided directly from the coolant air source to the air inlet of the at least one AFS injector through the additional cooling passage without passing through the aft frame.

11. The GT system of claim 10, wherein the first flow sleeve includes a first portion spaced from and parallel to the exterior surface of the tapered transition portion, and a second portion extending in an outwardly convex manner over the air inlet of the at least one AFS injector.

12. The GT system of claim 11, wherein the at least one AFS injector includes at least two AFS injectors circumferentially spaced along at least one of the cylindrical portion and the tapered transition portion, and the second portion of the first flow sleeve extends at least partially circumferentially around the tapered transition portion to fluidly connect the air inlets of the at least two AFS injectors.

13. (canceled)

14. (canceled)

15. The GT system of claim 10, wherein the first cooling passage in the aft frame has a non-linear flow path in the aft frame.

16. The GT system of claim 10, further comprising a second flow sleeve spaced along at least a portion of an exterior surface of the cylindrical portion and defining a third cooling passage having an inlet adjacent the at least one AFS injector and extending to a head end fuel nozzle assembly coupled to a forward end of the AM combustor body.

17. The GT system of claim 16, wherein the inlet to the third cooling passage is between an aft end of the second flow sleeve and a forward end of the first flow sleeve.

18. The GT system of claim 10, wherein the first flow sleeve extends forwardly on opposing circumferential sides of the at least one AFS injector.
